(19) United States
(12) Patent Application Publication
(10) Pub. No.: US 2016/0376006 A1
(43) Pub. Date: Dec. 29, 2016

(54) ROPE DEPLOYMENT MECHANISM FOR AN AIRCRAFT

(71) Applicant: Ovid Balten, Basking Ridge, NJ (US)

(72) Inventor: Ovid Balten, Basking Ridge, NJ (US)

(21) Appl. No.: 14/749,738

(22) Filed: Jun. 25, 2015

(51) Int. Cl. B64D 9/00

(52) U.S. Cl. CPC B64D 9/00

(57) ABSTRACT

A rope deployment mechanism for use on an aircraft is provided. The present invention includes a mounting bracket attachable to the aircraft. An arm assembly is pivotally connected to the mounting bracket about a vertical axis. A rope connector is disposed at an end of the arm assembly. The present invention further includes a dual link, compass style mechanism connecting the arm assembly to the support bracket and a locking mechanism operable to lock the rope deployment mechanism in a retracted position and a deployed position. Using the invention, the arm assembly may be pivoted to a deployed position, locked in the deployed position, and a rope may be attached to the rope connector all using one hand.

### BACKGROUND OF THE INVENTION

The present invention relates to descending, through rappelling or fast roping, from a flying aircraft and, more particularly, to a rope deployment mechanism for an aircraft.

Personnel insertion, extraction, rappel and evacuation from helicopters is performed under difficult conditions, such as being in flight and with the cabin door open. This operation presents a high level of risk as the operator has to position the rope deployment device, attach and secure the rope end fitting, and deploy the rope outboard while reaching outside the helicopter cabin door. To perform this mission the operator is secured with a safety harness and must hold one hand on a hand rail. Thus the operator has only one hand available to reach outside the cabin door to position the deployment device, attach and secure the rope end fitting and deploy the rope to ground at the end of the mission. To ensure mission safety, avoid accidents and thus comply with operational regulations, the above four distinct actions need to be performed by the operator safely and essentially using one hand only.

As can be seen, there is a need for an improved rope deployment mechanism for use on an aircraft that may be deployed and operated using one hand.

### SUMMARY OF THE INVENTION

In one aspect of the present invention, a rope deployment mechanism for use on an aircraft comprises: a mounting structure/bracket attachable to the aircraft structure hard points above the cabin door and forming an aerodynamic housing; an arm assembly pivotally connected to the mounting bracket about a vertical axis at a first end and comprising a rope connecting mechanism disposed at a second end; a first link pivotally connected to the mounting bracket about a vertical axis, and comprising an inner rim forming an inner housing; a second link pivotally connected to the first link about a vertical axis and pivotally connected to the arm about a vertical axis; and a locking mechanism operable to lock the rope deployment mechanism in a retracted position and a deployed position.

In another aspect of the present invention, a rope deployment mechanism for use on an aircraft comprises: a mounting bracket attachable to the aircraft; an arm assembly pivotally connected to the mounting bracket about a vertical axis at a first end; a rope connecting mechanism disposed at a second end of the arm assembly and comprising a hook disposed in between a first pivoting wing and a second pivoting wing; and a locking mechanism operable to lock the rope deployment mechanism in a retracted position and a deployed position.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a top view of an embodiment of the present invention shown in a deployed configuration;

FIG. 3 is a top view of an embodiment of the present invention shown in a retracted configuration;

FIG. 4 is a section view of the present invention along line A-A in FIG. 1;

FIG. 5 is an exploded view of an embodiment of the present invention;

FIG. 6 is a perspective view demonstrating the rope in a pre-clip configuration;

FIG. 7 is a perspective detail view demonstrating rope in a mid-clip configuration;

FIG. 8 is a perspective view demonstrating rope in a post clip configuration;

FIG. 9 is a side view demonstrating the present invention in use on a helicopter;

FIG. 10 is a top view demonstrating the present invention in use on a helicopter; and

FIG. 11 is a frontal view demonstrating the present invention in use on a helicopter.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a mechanical device for fast and safe deployment of personnel insertion, extraction, evacuation ropes from helicopters. The mechanical device disclosed herein provides the design features necessary to ensure rapid, reliable and safe deployment of personnel insertion, extraction and recovery ropes with one hand only. Furthermore, to enhance operation speed and reliability, the mechanical device disclosed herein allows for the rope end fitting attachment, securing and release from the helicopter by one hand in a one handed motion.

To ensure the rapid deployment, reliability and safety mission requirements applicable to deployment of personnel insertion, extraction, rappel and evacuation ropes from helicopters are met, the device disclosed herein has been designed to incorporate the following features: (i) a compass style deploying mechanism operable by one hand; (ii) a locking device for the compass style mechanism allowing for locking the mechanism in the stowed (inboard) position and deployed (outboard) position operable by one hand; (iii) an attachment device for the rope provided with a dual safety retainer operable with one hand in one motion; and (iv) a lockable rope release mechanism operable with one hand in one motion. The present invention further integrates double safety features to prevent malfunction and to comply with aviation industry standards.

The present invention may include a mounting bracket assembly made of a high strength aluminum alloy and providing the mechanical interface between the helicopter structure and the arm assembly. The mounting bracket also provides the mechanical interfaces to the arm assembly and compass assembly links. The arm assembly is a sub-assembly and may be made of a high strength aluminum alloy incorporating the following items: a hook and retainer assembly; a mechanical release assembly; a mounting bracket for the second link; and a hinge interface to the mounting bracket. The first link may be made of a high strength aluminum alloy and may include an antifriction bearing providing the link between the mounting bracket and the second link. The second link may be made of a high strength aluminum alloy and is provided with an anti-friction bearing. The second link provides the linkage between first link and the arm assembly. The linkage mechanism including the first link and the second link is essentially a compass assembly that is folded for arm assembly stowage or opened for arm assembly deployment. Further to the compass folding action, the first and second links provide structural support to the arm assembly.

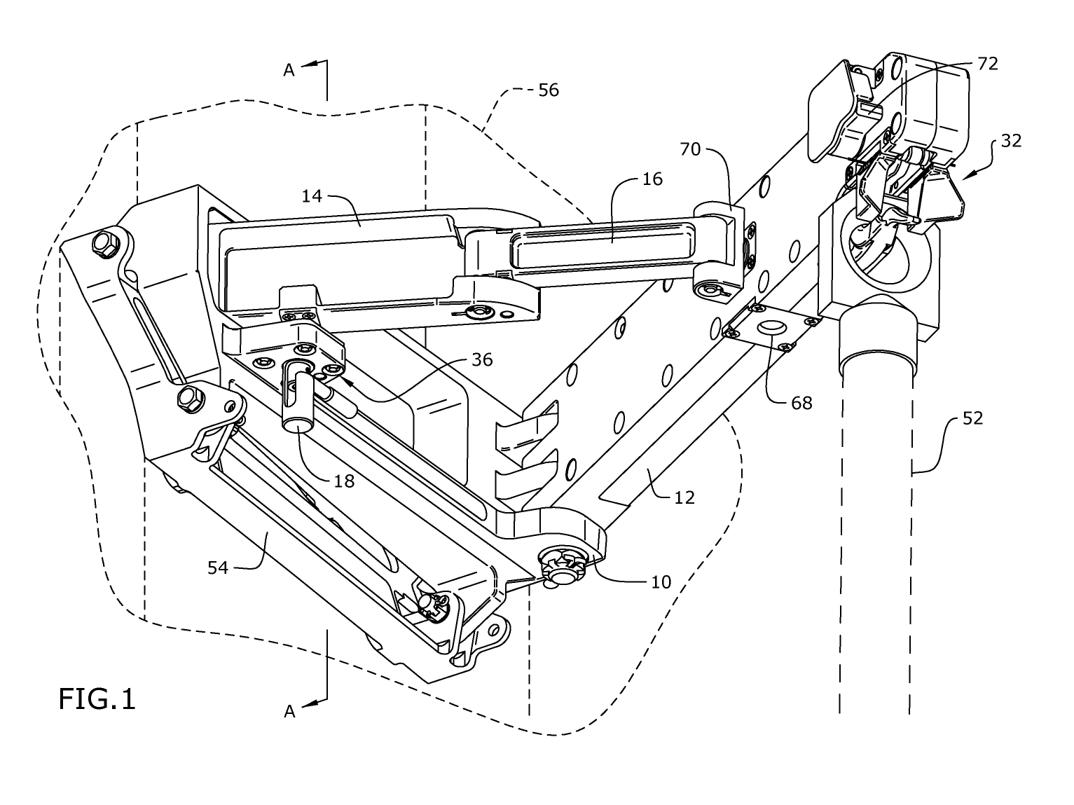

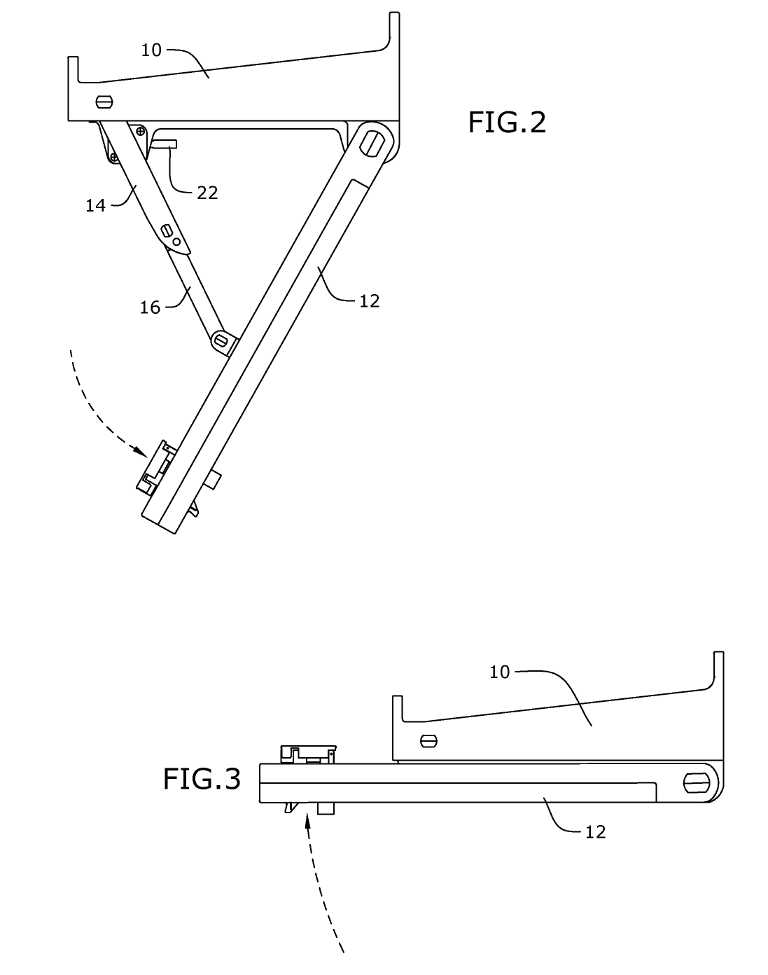

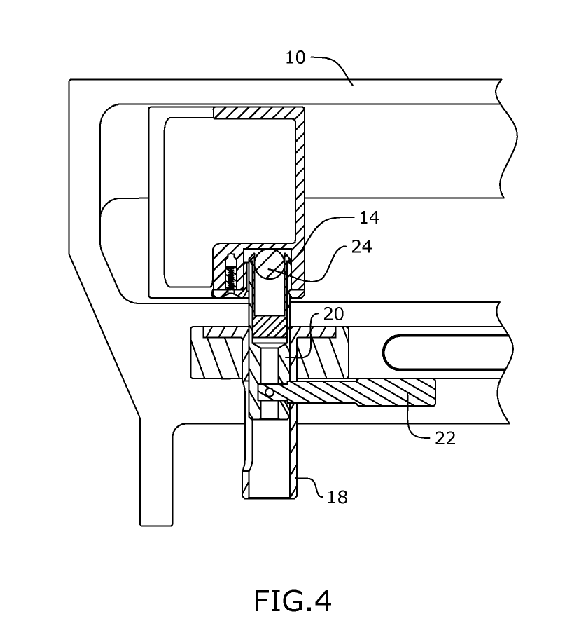

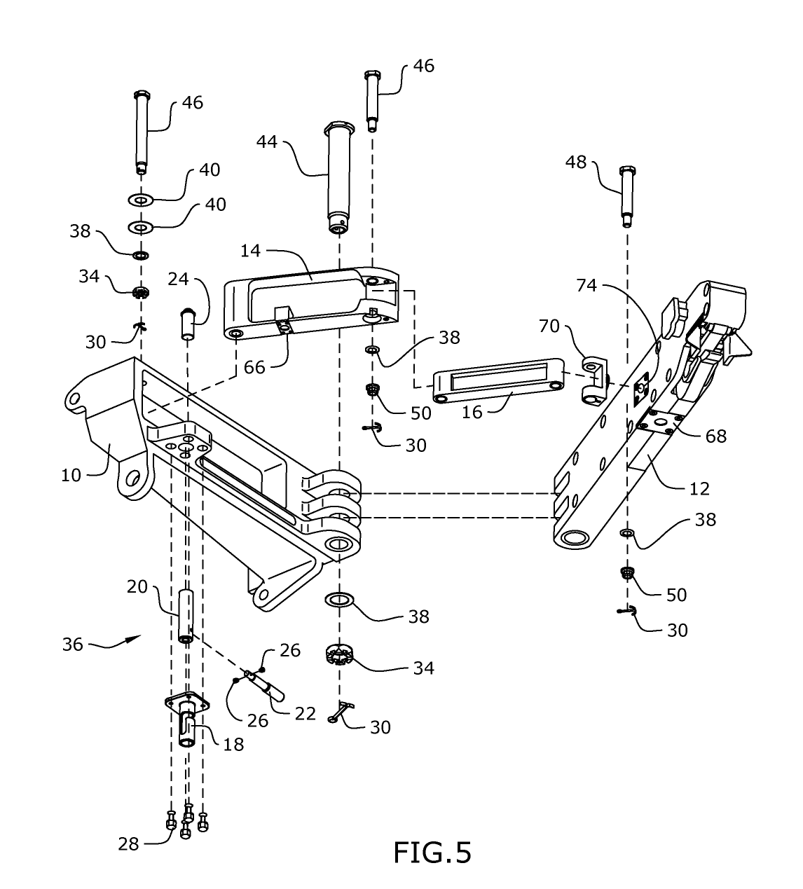

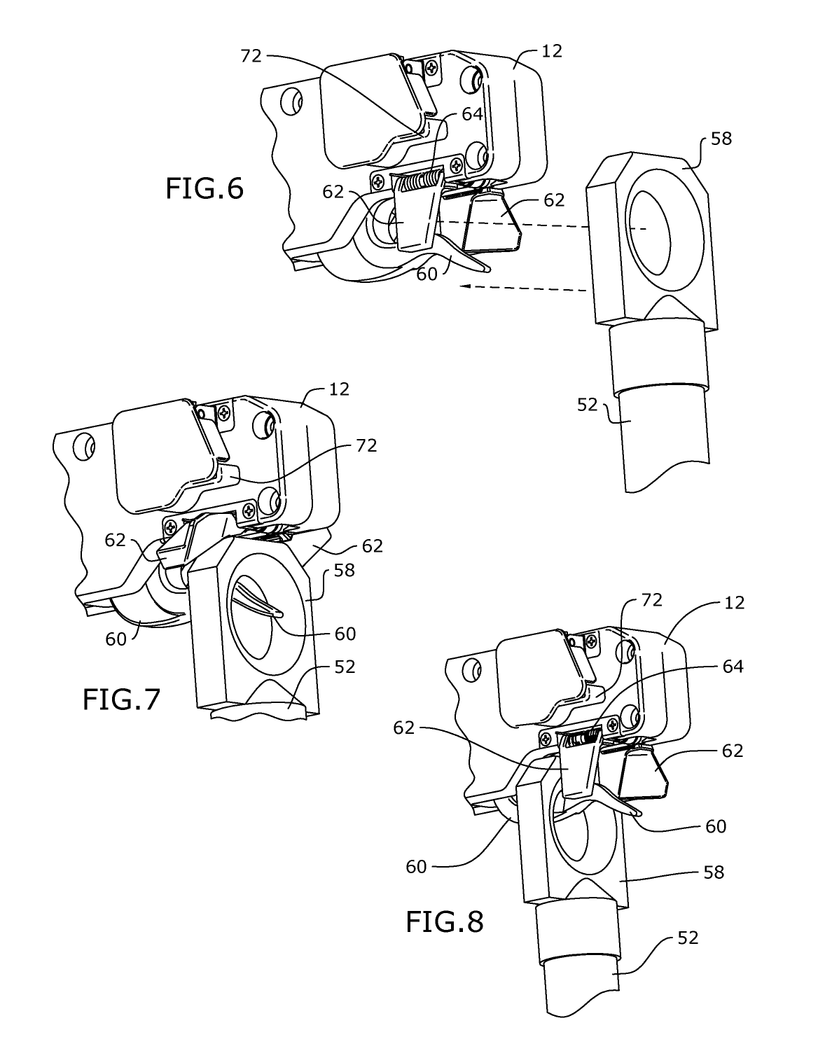

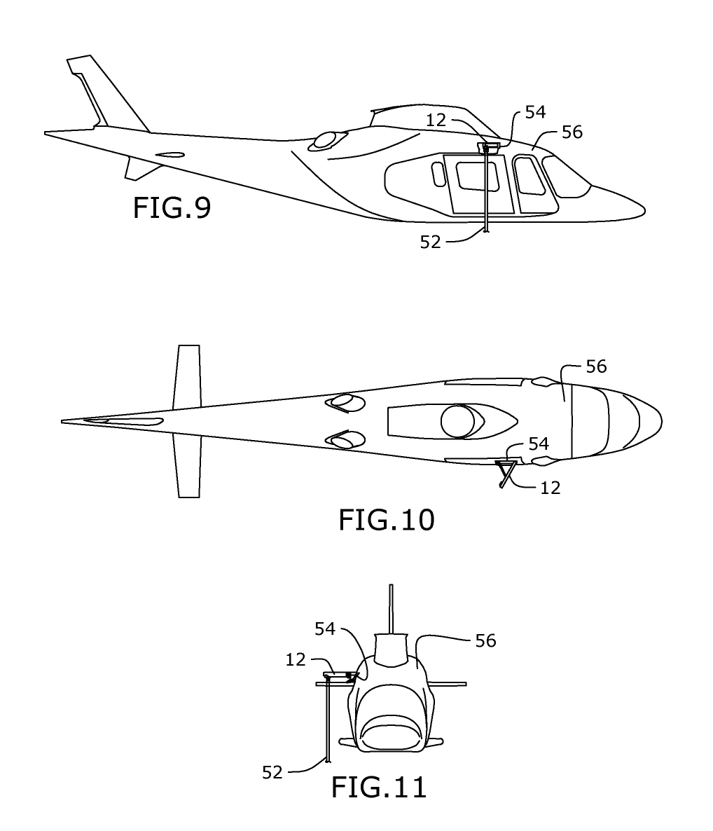

Referring to FIGS. 1 through 11, the present invention includes a rope deployment mechanism for use on an aircraft, such as a helicopter 56. The present invention includes a mounting bracket 10. The mounting bracket 10 is attached to the helicopter 56 by a helicopter support plate 54. The mounting bracket 10 includes an inner rim forming an aerodynamic housing. The present invention further includes an arm assembly 12 pivotally connected to the mounting bracket 10 about a vertical axis at a first end. A rope connector 32 is disposed at a second end of the arm assembly 12. The present invention may further include a first link 14 and a second link 16 forming a compass assembly. The first link 14 includes an inner rim forming an inner housing and is pivotally connected to the mounting bracket 10 about a vertical axis. The second link 16 is pivotally connected to the first link 14 about a vertical axis and pivotally connected to the arm 12 about a vertical axis. A locking mechanism 36 is operable to lock the rope deployment mechanism in a retracted position and a deployed position.

The retracted position includes the first link 14 within the housing of the mounting bracket 10, the second link 16 within the housing of the first link 14 and the arm assembly 12 abutting and substantially parallel with the mounting bracket 10. The present invention may be in the retracted position while the helicopter 56 is flying. The deployed position includes the first link 14 pivoted away from the mounting bracket 10, the second link 16 pivoted away from the first link 14 and the arm assembly 12 pivoted away from the mounting bracket 10. In the deployed position, the arm assembly 12 may be positioned at a 60 degree lateral angle relative to the helicopter centerline and away from the aircraft fuselage and aircraft landing gear to allow unobstructed and safe deployment operation. When a user is ready to deploy out of the helicopter 56 via a rope 52, the user first attaches the rope end fitting 58 to the hook 60 using one hand in a single motion. The rope end fitting 58 is retained safely on the hook 60 by pivoting wings 62. The user may pivot the arm 12 to the deployed position with one hand and lock the arm 12 in the deployed position using the locking mechanism 36. Locking the arm 12 in the deployed position may also be performed with one hand only. The user may then deploy the rope 52 out of the helicopter 56 to the ground. At this point the user may deploy out of aircraft 56 to the ground using rope 12.

The pivotal connections of the present invention may include double safety features. The arm 12 may be pivotally connected to the mounting bracket 10 by an interlocking hinge. A bolt 44 may run through the interlocking hinge and may be secured within the hinge by a castellated nut 34 and a washer 38. The bolt 44 may be additionally secured to the hinge by a cotter pin 30 that runs through a pin hole at a bottom end of the bolt 44. The first link 14 may be pivotally connected within the housing of the mounting bracket 10 by a bolt 46 running through aligning apertures formed in the first link 14 and the mounting bracket 10. The bolt 46 may be secured within the aligning apertures by a castellated nut 34, a flat washer 38 and a plurality of spacer antifriction washers 40. The bolt 46 may be additionally secured within the apertures by a cotter pin 30 that runs through a pin hole at a bottom end of the bolt 46. The second link 16 may be pivotally connected within the housing of the first link 14 by a bolt 46 running through aligning apertures formed in the first link 14 and the second link 16. The bolt 46 may be secured within the aligning apertures by a self locking nut 50 and a flat washer 38. The bolt 46 may be additionally secured within the apertures by a cotter pin 30 that runs through a pin hole at a bottom end of the bolt 46.

In certain embodiments, the present invention includes a self aligning clevis bracket 70. The self aligning clevis bracket 70 includes a bracket portion, a shaft extension and a spherical connector. The bracket portion is pivotally connected to the second link 16 about the vertical axis, and the spherical connector is rotatably connected within the arm assembly 12. A plate 74 protects the arm assembly 12 from direct contact with the clevis bracket 70. The spherical connection allows for three (3) degrees of movement, specifically rotation about x, y and z axis, between the arm assembly 12 and clevis bracket 70. Therefore, when the arm 12 is pivoting away from and towards the mounting bracket 10, the rotating connection may provide additional give and alignment, allowing for a smoother and easier pivoting and folding motion. The second link 16 may be pivotally connected to the clevis bracket 70 utilizing the double safety features. The second link 16 may be pivotally connected to the bracket portion by a bolt 48 running through aligning apertures formed in the second link 16 and the bracket portion. The bolt 48 may be secured within the aligning apertures by a self locking nut 50 and a flat washer 38. The bolt 48 may be additionally secured within the apertures by a cotter pin 30 that runs through a pin hole at a bottom end of the bolt 48.

As mentioned above, the present invention includes a locking mechanism 36 to lock the arm assembly 12 in the retracted position and the deployed position. The locking mechanism 36 may include a lock pin housing 18. The lock pin housing 18 is attached to the mounting bracket 10 by a flange protruding from the mounting bracket 10. The lock pin housing 18 may include a mounting surface mounted to a portion of the flange via bolts 28 running through aligning apertures. The lock pin housing 18 may include a sidewall protruding substantially perpendicular from the mounting surface. A vertical slot and a horizontal slot are formed through the sidewall, with the horizontal slot extending from a top end of the vertical slot. A locking pin 20 is disposed within the housing. A lever 22 is attached to the locking pin 20 via pin set screws 26. The lever 22 extends out of the lock pin housing 18 and may run along the vertical and horizontal slots. The lever 22 may be maneuvered in the vertical slot allowing the locking pin 20 to recess into the lock pin housing 18 and pushed up to the horizontal slot to retain a top portion of the lever 22 outside of the lock pin housing 18. The locking mechanism 36 may further include a plunger 24 having a bearing ball tip. The plunger 24 may fit within the locking pin 20, and the bearing ball tip may extend from a top end of the locking pin 20.

In such embodiments, a first receiver 66 may be formed on a bottom side of the first link 14, and a second receiver 68 may be formed on the bottom side of the arm assembly 22. In a retracted and locked position, the present invention includes the lever 22 disposed within the horizontal slot and the locking pin 20 locked within the second receiver 68. To unlock the present invention, the user may pivot the lever 22 along the horizontal slot and into the vertical slot, dropping the top of the locking pin 20 and the plunger 24 into the lock pin housing 18. Due to the spring loaded ball on the plunger 24, the lever 22 is easily rotated from the horizontal slot to the vertical slot. The user may then pivot the arm assembly 12 to the deployed position. With the arm assembly 12 in the fully deployed position, the first link 14 and the second link 16 are aligned and retained in the aligned position by a set of plungers located inside link 14. To securely lock the present invention in the deployed position, a user may lift up the lever 22 within the lock pin housing 18 through the vertical slot and pivot the lever into the horizontal slot. As lever 22 is pushed up in the vertical slot moving lock pin 20 together with plunger 24 into first receiver 66 at the bottom of first link 14, the spring loaded ball of the plunger 24 is compressed within the first receiver 66, thereby locking the arm assembly 12 in the deployed position.

As mentioned above, the present invention includes a rope connecter 32 disposed at distal end of the arm assembly 12. The rope connector 32 includes a hook 60 disposed in between a first pivoting wing 62 and a second pivoting wing 62. The first pivoting wing 62 and the second pivoting wing 62 are pivotally connected to the arm assembly 12 about a horizontal axis and are protruding downward surrounding the hook 60. Each of the pivoting wings 62 includes a front portion bent away from one another and a spring 64 resiliently retaining the first and second pivoting wings 62 against a stopper of the arm assembly 12, which suspends the pivoting wings 62 in a substantially parallel position relative to one another. The springs 64 permit the first pivoting wing 62 and the second pivoting wing 62 to pivot away from one another against resiliency of the springs 64 when a force is applied against the front portions. Therefore, a user may press a rope ring 58 against the wings 62 with one hand. The wings 62 are pushed away from one another against the torsion springs, permitting the rope ring 58 to slide onto the hook 60. Once the rope ring 58 is attached to the hook 60, the wings 62 are biased back towards one another by the torsion springs, resting against the stopper, and preventing the rope ring 58 from unhooking. The present invention may further include a release button 72. To unhook the rope ring 58 from the hook 60, the user may activate the release button 72, allowing the hook 60 retaining mechanism to open and thus allowing the rope ring 58 to slide freely off of the hook 60. By activating the release button 72, the hook 60 is rotated downwards, allowing the rope ring 58 to slide off. To prevent inadvertent actuation of the release button 72 this is protected by a spring loaded cover. To actuate (rotate) the release button from the locked positioned (horizontal) towards the release position (vertical down), the protection cover is lifted by rotating upwards. Rotating the protection cover upwards and rotating the release button downwards can be done with one hand only using the thumb and index fingers simultaneously.

It should be understood, of course, that the foregoing relates to exemplary embodiments of the invention and that modifications may be made without departing from the spirit and scope of the invention as set forth in the following claims.

What is claimed is:

1. A rope deployment mechanism for an aircraft comprising:
a mounting bracket attachable to the aircraft and comprising an inner rim forming a housing;
an arm assembly pivotally connected to the mounting bracket about a vertical axis at a first end and comprising a rope connector disposed at a second end;
a first link pivotally connected to the mounting bracket about a vertical axis, and comprising an inner rim forming an inner housing;
a second link pivotally connected to the first link about a vertical axis and pivotally connected to the arm about a vertical axis; and
a locking mechanism operable to lock the rope deployment mechanism in a retracted position and a deployed position.

2. The rope deployment mechanism of claim 1, wherein the retracted position comprises the first link within the housing of the mounting bracket, the second link within the housing of the first link and the arm abutting and substantially parallel with the mounting bracket, wherein the deployed position comprises the first link pivoted away from the mounting bracket, the second link pivoted away from the first link and the arm pivoted away from the mounting bracket.

3. The rope deployment mechanism of claim 2, wherein the locking mechanism comprises:
a lock pin housing mounted to the mounting bracket and comprising a vertical slot and a horizontal slot extending from a top end of the vertical slot;
a locking pin disposed within the housing;
a lever attached to the locking pin and extending out of the lock pin housing through at least one of the vertical and horizontal slots;
a first receiver disposed through the first link and a second receiver disposed through the arm,
wherein a retracted and locked position comprises the lever disposed within the horizontal slot and the locking pin locked within the second receiver, wherein an unlocked position comprises the lever pivoted to and disposed within the vertical slot, wherein a deployed and locked position comprises the lever pivoted and disposed within the horizontal slot and the locking pin locked within the first receiver.

4. The rope deployment mechanism of claim 3, wherein the locking mechanism further comprises a plunger comprising a bearing ball tip extending from a top end of the locking pin.

5. The rope deployment mechanism of claim 1, further comprising a rotating bracket comprising a bracket portion and a spherical connector, wherein the bracket portion is pivotally connected to the second link about the vertical axis, and the spherical connector is rotatably connected to the arm.

6. The rope deployment mechanism of claim 1, wherein the rope connector comprises a hook disposed in between a first pivoting wing and a second pivoting wing.

7. The rope deployment mechanism of claim 6, wherein the first pivoting wing and the second pivoting wing are pivotally connected to the arm about a horizontal axis, wherein each of the first and second pivoting wings comprise:
a front portion bent away from one another; and
a spring resiliently retaining the first and second pivoting wings in a substantially parallel position relative to one another,
wherein the springs permit the first pivoting wing and the second pivoting wing to pivot away from one another against resiliency of the springs when a force is applied against the front portions of the wings.

8. A rope deployment mechanism for an aircraft comprising:
a mounting bracket attachable to the aircraft;
an arm assembly pivotally connected to the mounting bracket about a vertical axis at a first end;
a rope connector disposed at a second end of the arm assembly and comprising a hook disposed in between a first pivoting wing and a second pivoting wing; and
a locking mechanism operable to lock the rope deployment mechanism in a retracted position and a deployed position.

9. The rope deployment mechanism of claim 8, wherein the first pivoting wing and second pivoting wing are pivotally connected to the arm about a horizontal axis, wherein each of the first and second pivoting wings comprise:
a front portion bent away from one another; and
a spring resiliently retaining the first and second pivoting wings in a substantially parallel position relative to one another,
wherein the springs permit the first pivoting wing and the second pivoting wing to pivot away from one another against resiliency of the springs when a force is applied against the front portions.

10. The rope deployment mechanism of claim 9, further comprising a release button to pivot downward and away from the first and second pivoting wings when activated.
